(19) United States
(12) Patent Application Publication
(10) Pub. No.: US 2026/0315930 A1
(43) Pub. Date: Oct. 15, 2026

(54) Virtual World-Based Interaction Method and Apparatus, Device, and Computer-Readable Storage Medium

(71) Applicant: Tencent Technology (Shenzhen) Company Limited, Shenzhen (CN)

(72) Inventors: Nengjie Zhu, Shenzhen (CN); Yulong Wang, Shenzhen (CN); Xinyu Yin, Shenzhen (CN); Ziwen Huang, Shenzhen (CN); Guoxing Zhang, Shenzhen (CN)

(21) Appl. No.: 19/681,625

(22) Filed: May 19, 2026

Related U.S. Application Data
(63) Continuation of application No. PCT/CN2025/109008, filed on Jul. 17, 2025.

(30) Foreign Application Priority Data
Aug. 19, 2024 (CN) 2024111411932

(51) Int. Cl. A63F 13/57; A63F 13/52; A63F 13/537

(52) U.S. Cl. CPC A63F 13/57; A63F 13/52; A63F 13/537

(57) ABSTRACT

A virtual world-based interaction method and apparatus, a device, and a computer-readable storage medium are provided. The method comprises: displaying a first pet character and a second pet character that are in a virtual world; and displaying that the first pet character and the second pet character perform a species interaction behavior The method further comprises controlling, in response to a combat trigger event, a virtual player character to switch from a virtual world exploration state to a turn-based combat state; and controlling the first pet character and the second pet character to enter the turn-based combat state in a combat mode corresponding to the species interaction behavior.

### RELATED APPLICATIONS

This application claims priority to PCT/CN2025/109008, filed on Jul. 17, 2025, which claims priority to Chinese Patent Application No. 202411141193.2, entitled " VIRTUAL WORLD-BASED INTERACTION METHOD AND APPARATUS, DEVICE, AND COMPUTER-READABLE STORAGE MEDIUM" and filed on Aug. 19, 2024, each of which is incorporated herein by reference in its entirety.

### FIELD OF THE TECHNOLOGY

This application relates to the field of computer technologies, and in particular, to a virtual world-based interaction method and apparatus, a device, and a computer-readable storage medium.

### BACKGROUND OF THE DISCLOSURE

With continuous development of computer technologies, various types of clients (e.g., terminal devices) emerge, including a client that performs an interaction based on a virtual world. People pose increasingly high requirements on flexibility and fun of virtual world-based interactions. Therefore, a virtual world-based interaction method needs to be provided, to improve flexibility and fun of the interactions, thereby increasing an interaction rate and a user retention rate.

### SUMMARY

This application provides a virtual world-based interaction method and apparatus, a device, and a computer-readable storage medium, to improve flexibility and fun of an interaction, and increase an interaction rate and a user retention rate. Technical solutions are as follows:

According to an aspect, an example of this application provides a virtual world-based interaction method, the method being performed by a computer device, and the method comprising: displaying a first pet character and a second pet character that are in a virtual world. The first pet character and the second pet character may belong to the same species or different species. The method also comprises displaying that the first pet character and the second pet character perform a species interaction behavior; controlling, in response to a combat trigger event, a virtual player character to switch from a virtual world exploration state to a turn-based combat state; and controlling the first pet character and the second pet character to enter the turn-based combat state in a combat mode corresponding to the species interaction behavior.

According to another aspect, an example of this application provides a virtual world-based interaction apparatus, the apparatus comprising: a display module, configured to display a first pet character and a second pet character that are in a virtual world. The first pet character and the second pet character may belong to the same species or different species. The display module is further configured to display that the first pet character and the second pet character perform a species interaction behavior. The apparatus also comprises a control module, configured to control, in response to a combat trigger event, a virtual player character to switch from a virtual world exploration state to a turn-based combat state, and control the first pet character and the second pet character to enter the turn-based combat state in a combat mode corresponding to the species interaction behavior.

According to another aspect, an example of this application provides a computer device, the computer device including a processor and a memory, the memory having at least one piece of program code stored therein, and the at least one piece of program code being loaded and executed by the processor, to cause the computer device to implement the virtual world-based interaction method according to any one of the foregoing implementations.

According to another aspect, a non-transitory non-volatile computer-readable storage medium is further provided, the non-transitory non-volatile computer-readable storage medium including at least one piece of program code, and the at least one piece of program code being loaded and executed by a processor, to cause a computer to implement the virtual world-based interaction method according to any one of the foregoing implementations.

According to another aspect, a computer program or a computer program product is further provided, the computer program or the computer program product having at least one computer instruction stored therein, and the at least one computer instruction being loaded and executed by a processor, to cause a computer to implement the virtual world-based interaction method according to any one of the foregoing implementations.

In the technical solutions provided in the examples of this application, when the virtual player character enters the turn-based combat state, the first pet character and the second pet character also enter the turn-based combat state, and the first pet character and the second pet character enter the turn-based combat state in the combat mode corresponding to the species interaction behavior performed by the first pet character and the second pet character before the first pet character and the second pet character enter the turn-based combat state, so that a relationship that is between the first pet character and the second pet character and that exists before the first pet character and the second pet character enter the turn-based combat state continues into the turn-based combat state. The relationship that is between the first pet character and the second pet character and that exists before the turn-based combat state is entered is consistent with a relationship that is between the first pet character and the second pet character and that exists after the turn-based combat state is entered, thereby reducing a disconnection between the relationship existing before the turn-based combat state is entered and the relationship existing after the turn-based combat state is entered, making interaction experience more complete, and improving immersion of a player, so that an interaction rate and a user retention rate can be increased.

In addition, after the virtual player character, the first pet character, and the second pet character enter the turn-based combat state, the virtual player character not only may perform a turn-based combat with the first pet character, but also may perform a turn-based combat with the second pet character, thereby reducing a limitation of an interaction by the virtual player character in a virtual world, making the interaction by the virtual player character in the virtual world more flexible and interaction manners in the virtual world more diversified, and making the interaction funnier, so that an interaction rate and a user retention rate can be increased.

In addition, based on the method provided in the examples of this application, a client can continuously produce various species interaction behaviors and combat modes, so that interaction diversity can be improved, and an interaction rate and a user retention rate are further increased.

### BRIEF DESCRIPTION OF THE DRAWINGS

FIG. 1 is a schematic diagram of a computer system according to an example of this application.

FIG. 2 is a flowchart of a virtual world-based interaction method according to an example of this application.

FIG. 3 is a schematic diagram of display of a game interaction interface according to an example of this application.

FIG. 4 is a schematic diagram of a first pet character and a second pet character performing a daily grouping-up interaction behavior according to an example of this application.

FIG. 5 is a schematic diagram of a first pet character and a second pet character performing a stress protection interaction behavior according to an example of this application.

FIG. 6 is a schematic diagram of display of a first pet character and a second pet character performing an intimate interaction behavior according to an example of this application.

FIG. 7 is a schematic diagram of display of a first pet character and a second pet character performing an interactive brawling interaction behavior according to an example of this application.

FIG. 8 is a schematic diagram of display of another game interaction interface according to an example of this application.

FIG. 9 is a schematic diagram of display of a third pet character and a reference pet character according to an example of this application.

FIG. 10 is a schematic diagram of display of a manner of substituting for a pet character according to an example of this application.

FIG. 11 is a schematic diagram of display of another manner of substituting for a pet character according to an example of this application.

FIG. 12 is a flowchart of a virtual world-based interaction method according to an example of this application.

FIG. 13 is a schematic diagram of a structure of a virtual world-based interaction apparatus according to an example of this application.

FIG. 14 is a schematic diagram of a structure of a terminal device according to an example of this application.

FIG. 15 is a schematic diagram of a structure of a server according to an example of this application.

### DESCRIPTION OF EMBODIMENTS

To make the objectives, technical solutions, and advantages of this application clearer, the following further describes implementations of this application in detail with reference to the accompanying drawings.

The terms "first", "second", and the like in this application are intended to distinguish similar objects but do not necessarily indicate a specific order or sequence. Such used terms are interchangeable where appropriately, so that the examples of this application described herein can be implemented in a sequence other than those illustrated or described herein. The implementations described in the following examples do not indicate all implementations consistent with this application. On the contrary, the implementations are merely examples of an apparatus and a method that are consistent with some aspects of this application described in detail in the claims.

First, abbreviations and key terms mentioned in the examples of this application are defined.

A virtual world is an environment provided (or displayed) when an application program runs on a terminal device. The virtual world is an environment created for a virtual object to conduct activities. The virtual world may be a two-dimensional virtual environment, a 2.5-dimensional virtual environment, a three-dimensional virtual environment, or the like. The virtual world may be a simulated environment of the real world, a semi-simulated environment of the real world, or a completely fictional environment. For example, the virtual world mentioned in the examples of this application is a three-dimensional virtual environment. In some examples, alternatively, the virtual world may be referred to as a virtual environment, a virtual scenario, or the like.

A virtual character is a movable object in a virtual world. The movable object may be a virtual character, a virtual animal, a cartoon character, or the like. A player may control the virtual character by using a peripheral component or by tapping or touching a display screen. Each virtual character has its own shape and volume in the virtual world, occupying a part of space in the virtual world. For example, when the virtual world is a three-dimensional virtual environment, the virtual character is a three-dimensional model created based on a skeletal animation technology. In some examples, a player may alternatively be referred to as a user, an interaction object, a game object, or the like. The virtual character may alternatively be referred to as a virtual object or the like.

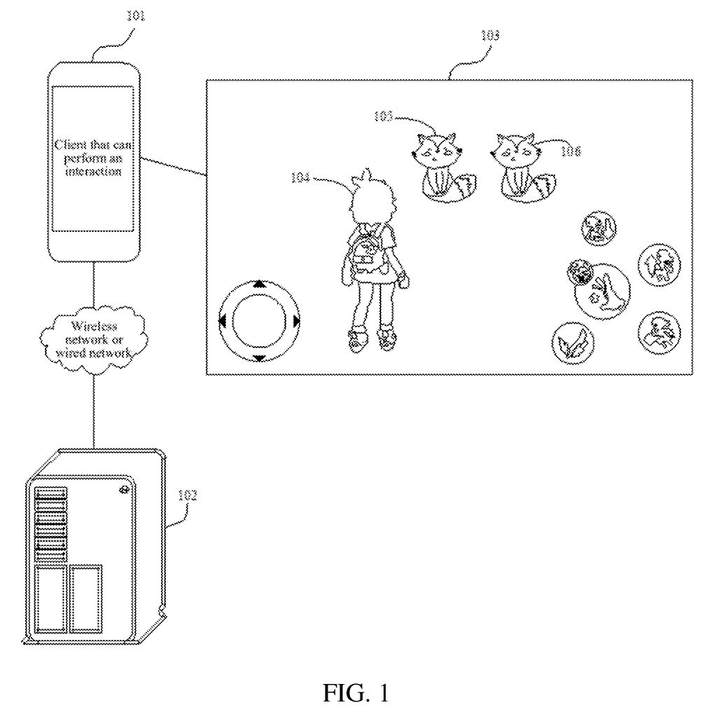

FIG. 1 is a schematic diagram of a computer system according to an example of this application. As shown in FIG. 1, the computer system includes a terminal device 101 and a server 102. A client that can perform an interaction is installed and run in the terminal device 101. A virtual world-based interaction method provided in the examples of this application may be performed by the terminal device 101, or may be performed by both the terminal device 101 and the server 102. This is not limited in this example of this application.

The server 102 is configured to provide a background service for the client that can perform an interaction and that is installed in the terminal device 101. In a possible implementation, the server 102 is in charge of primary computing work, and the terminal device 101 is in charge of secondary computing work. Alternatively, the server 102 is in charge of the secondary computing work, and the terminal device 101 is in charge of the primary computing work. Alternatively, collaborative computing is performed between the terminal device 101 and the server 102 through a distributed computing architecture.

For example, the client that can perform an interaction may be a game client, or may be a client of another type. This is not limited in this example of this application. When the client that can perform an interaction is a game client, the game client may be a third-person shooting (TPS) game, a first-person shooting (FPS) game, a multiplayer online battle arena (MOBA) game, a multiplayer shooting survival game, a massive multiplayer online role-playing game (MMO), or an action role playing game (ARPG). In some examples, the game client may alternatively be referred to as a game for short. For example, the client of another type may include a virtual reality (VR) client, an augmented reality (AR) client, a three-dimensional map program, a map simulation program, a social client, an interactive entertainment client, or the like.

The client that can perform an interaction may be a client that needs to be independently downloaded and installed, or may be an embedded program that is run depending on a host program. The embedded program is an application program that is run depending on a host program and that is developed based on a programming language. The embedded program does not need to be downloaded or installed, but only needs to be dynamically loaded in the host program to run. The embedded program includes but is not limited to a mini program. A type of the client is not limited in this example of this application. A user finds a needed embedded program in a manner such as searching and scanning, which can be run and used through clicking/tapping, and does not occupy an internal memory of a terminal device after being used and closed. This is very convenient. In addition, the client in this example of this application may be a client based on frame synchronization. That is, the virtual world-based interaction method provided in the examples of this application is applicable to the client based on frame synchronization. In some examples, the client may alternatively be referred to as an application program.

In one example, the terminal device 101 may be any electronic device product that can perform a human-machine interaction with the user in one or more manners of a keyboard, a touch pad, a remote control, a voice interaction, a handwriting device, or the like. For example, the terminal device 101 may be a smartphone, a tablet computer, a notebook computer, a desktop computer, a smart speaker, a smartwatch, a personal computer (PC), a mobile phone, a personal digital assistant (PDA), a wearable device, a pocket PC (PPC), a smart on-board unit, or a smart television.

The terminal device 101 may generally refer to one of a plurality of terminal devices. In this example, only the terminal device 101 is used as an example for description. A person skilled in the art can learn that there may be more or fewer terminal devices 101. For example, there may be only one terminal device 101, or there are dozens or hundreds of terminal devices 101, or more terminal devices 101. A quantity of terminal devices 101 and a device type are not limited in this example of this application.

The server 102 is one server, a server cluster including a plurality of servers, or either of a cloud computing platform or a virtualization center. This is not limited in this example of this application. The server 102 and the terminal device 101 are communicatively connected directly or indirectly through wired communication or wireless communication. The server 102 has a data receiving function, a data processing function, and a data transmission function. The server 102 may further have another function. This is not limited in this example of this application.

In an example of this application, the terminal device 101 displays a game interaction interface 103. A virtual player character 104, a first pet character 105, and a second pet character 106 that are in a virtual world are displayed in the game interaction interface 103. The first pet character 105 and the second pet character 106 belong to the same species or different species. That the first pet character 105 and the second pet character 106 perform a species interaction behavior is displayed when the first pet character 105 and the second pet character 106 receive a group event. When the virtual player character 104 intends to perform a turn-based combat, the virtual player character 104 summons a corresponding ally pet character. When the ally pet character is summoned, a combat trigger event is triggered, to control the virtual player character 104 to switch from a virtual world exploration state to a turn-based combat state, and to control the first pet character 105 and the second pet character 106 to enter the turn-based combat state in a combat mode corresponding to the species interaction behavior. In this case, the virtual player character 104, the first pet character 105, and the second pet character 106 perform the turn-based combat.

A person skilled in the art is to understand that the terminal device 101 and the server 102 are only examples for description, and other existing or future possible terminal devices or servers, if applicable to this application, are also to be included in the protection scope of this application, and are included herein by reference.

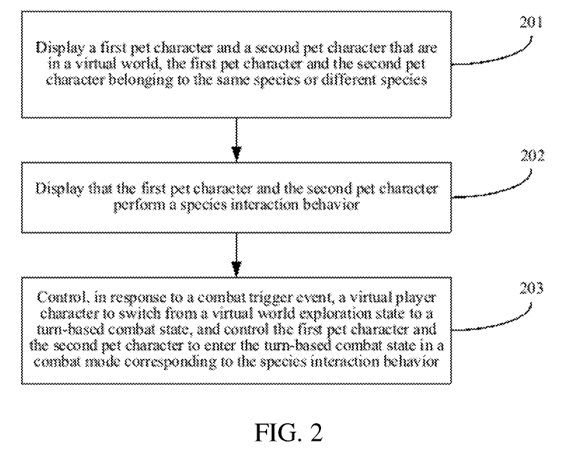

An example of this application provides a virtual world-based interaction method, applicable to the foregoing implementation environment shown in FIG. 1. For example, in a flowchart of the virtual world-based interaction method according to the example of this application shown in FIG. 2, the method may be performed by a computer device. The computer device may include the terminal device 101 in FIG. 1, or may include the server 102 in FIG. 1. This example of this application is described by using an example in which the virtual world-based interaction method is performed by the terminal device 101 in FIG. 1. As shown in FIG. 2, the method includes the following operation 201 to operation 203.

Operation 201: Display a first pet character and a second pet character that are in a virtual world, the first pet character and the second pet character belonging to the same species or different species.

In an example of this application, related information of a client that can perform an interaction is displayed in a display interface of the terminal device. The related information of the client may be a name of the client, an icon of the client, or other information that can uniquely represent the client. This is not limited in this example of this application.

For example, a process of displaying the first pet character and the second pet character that are in the virtual world includes: in response to a trigger operation performed by a game object on the related information of the client that can perform an interaction, displaying the first pet character and the second pet character that are in the virtual world. The client that can perform an interaction may be a game client, or may be a client of another type. This example of this application is described by using only an example in which the client that can perform an interaction is a game client.

In some examples, when the client that can perform an interaction is a game client, when a game object intends to run the client, the game object selects related information of the client, and the terminal device receives a trigger operation on the related information of the client, and displays the first pet character and the second pet character that are in the virtual world. In one example, the first pet character and the second pet character are non-player characters (NPC) in a game. The first pet character and the second pet character belong to the same species or different species.

In a possible implementation, when a type of the first pet character is the same as a type of the second pet character, the first pet character and the second pet character belong to the same species. When a type of the first pet character is different from a type of the second pet character, the first pet character and the second pet character belong to different species.

For example, if a type of the first pet character is a cat, and a type of the second pet character is a cat, the first pet character and the second pet character belong to the same species because the type of the first pet character is the same as the type of the second pet character. For another example, if a type of the first pet character is a cat, and a type of the second pet character is a dog, the first pet character and the second pet character belong to different species because the type of the first pet character is different from the type of the second pet character.

In one example, in response to the trigger operation on the related information of the client, an interaction interface is displayed, and the first pet character and the second pet character that are in the virtual world are displayed in the interaction interface. When the client that can perform an interaction is a game client, the interaction interface is a game interaction interface. In other words, in response to the trigger operation on the related information of the client, the game interaction interface is displayed, and the first pet character and the second pet character that are in the virtual world are displayed in the game interaction interface.

For example, the game object selecting the related information of the client may be the game object clicking the related information of the client, may be the game object selecting the related information of the client in a voice control manner, or may be the game object selecting the related information of the client in a gesture control manner. A manner of selecting the related information of the client is not limited in this example of this application.

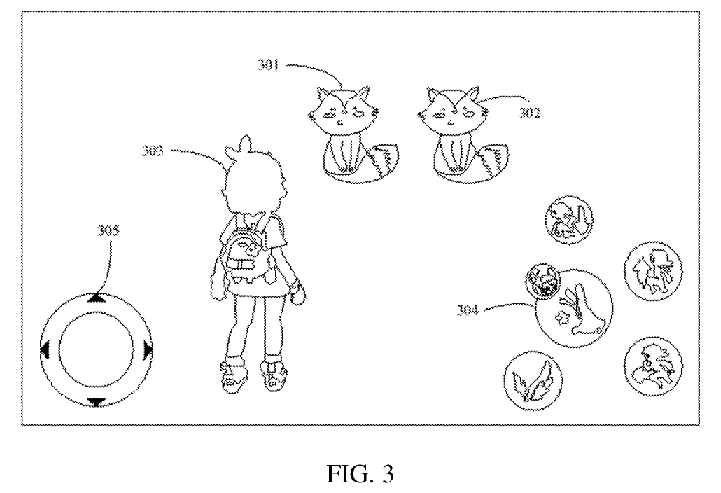

FIG. 3 is a schematic diagram of display of a game interaction interface according to an example of this application. A first pet character 301 and a second pet character 302 that are in a virtual world are displayed in the game interaction interface shown in FIG. 3. The first pet character 301 and the second pet character 302 belong to the same species.

In one example, a virtual player character may further be displayed in an interaction interface. For example, when the interaction interface is the game interaction interface, the virtual player character may further be displayed in the game interaction interface, the virtual player character is a virtual character controlled by a game object, the virtual player character has an ally pet character, and the ally pet character is a pet character obtained by the virtual player character. 303 in FIG. 3 is a virtual player character.

Other information may further be displayed in the interaction interface (for example, a game interaction interface). For details, refer to the game interaction interface shown in FIG. 3. Details are not described herein again in this example of this application.

In addition, the virtual player character in the virtual world is in a virtual world exploration state. In the virtual world exploration state, the virtual player character can freely explore and move to interact with the virtual world, to obtain an instant feedback based on an interaction behavior.

Operation 202: Display that the first pet character and the second pet character perform a species interaction behavior.

For example, the species interaction behavior is determined based on a relationship between a species of the first pet character and a species of the second pet character.

In a possible implementation, the first pet character and the second pet character perform the species interaction behavior when the first pet character and the second pet character receive a group event. The species interaction behavior includes an intra-specific interaction behavior and an inter-specific interaction behavior. In one example, the inter-specific interaction behavior includes an inter-specific intimate interaction behavior and an inter-specific hostile interaction behavior. In other words, the species interaction behavior includes the intra-specific interaction behavior, the inter-specific intimate interaction behavior, and the inter-specific hostile interaction behavior. The group event is configured for instructing the first pet character to perform an intra-specific interaction behavior when the first pet character meets a pet character in the same species, to perform an inter-specific intimate interaction behavior when the first pet character meets a pet character that is in a different species but in an intimate relationship between the species, and to perform an inter-specific hostile interaction behavior when the first pet character meets a pet character that is in a different species but in a hostile relationship between the species. The case is also applicable to the second pet character, and details are not described herein again. When the virtual world further includes another pet character, the case is also applicable to the another pet character in the virtual world, and details are not described herein again.

In one example, in this operation, the species interaction behavior includes the intra-specific interaction behavior, and that the first pet character and the second pet character perform the intra-specific interaction behavior is displayed based on that the first pet character and the second pet character belong to the same species. The species interaction behavior performed by the first pet character and the second pet character matches the relationship between the species of the first pet character and the species of the second pet character. This helps improve a display effect of the species interaction behavior performed by the first pet character and the second pet character, thereby improving interaction experience and increasing an interaction rate.

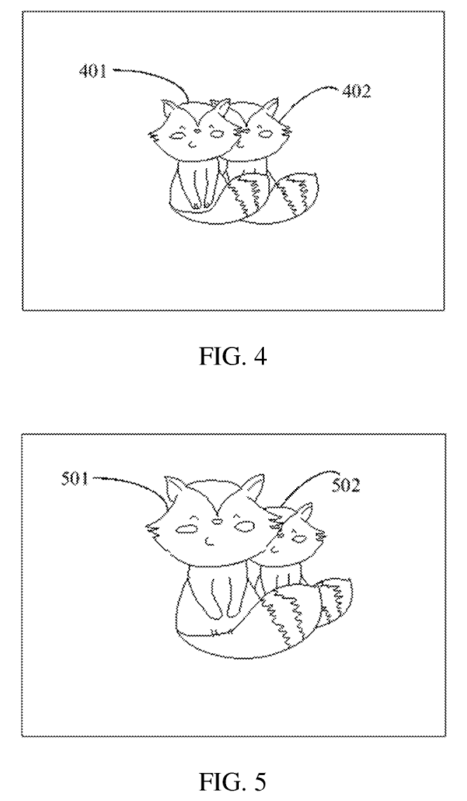

The intra-specific interaction behavior includes, but is not limited to, a daily grouping-up interaction behavior and a stress protection interaction behavior (a higher-tier pet character protects a lower-tier pet character). FIG. 4 is a schematic diagram of a first pet character and a second pet character performing a daily grouping-up interaction behavior according to an example of this application. The first pet character 401 and the second pet character 402 are grouping up and moving. FIG. 5 is a schematic diagram of a first pet character and a second pet character performing a stress protection interaction behavior according to an example of this application. The first pet character 501 is protecting the second pet character 502.

The species interaction behavior includes the inter-specific interaction behavior. Based on that the first pet character and the second pet character belong to different species, that the first pet character and the second pet character perform the inter-specific interaction behavior is displayed, and the inter-specific interaction behavior is different from the intra-specific interaction behavior. The species interaction behavior performed by the first pet character and the second pet character matches the relationship between the species of the first pet character and the species of the second pet character. This helps improve a display effect of the species interaction behavior performed by the first pet character and the second pet character, thereby improving interaction experience and increasing an interaction rate.

In some examples, pet characters in different groups may have a mutual intimate relationship and a mutual hostile relationship according to settings of ecology and habits. Therefore, the inter-specific interaction behavior includes an inter-specific intimate interaction behavior and an inter-specific hostile interaction behavior. When pet characters that are in different species but that are intimate with each other meet each other, an inter-specific intimate interaction behavior is performed. When pet characters that are in different species but that are hostile to each other meet each other, an inter-specific hostile interaction behavior is performed.

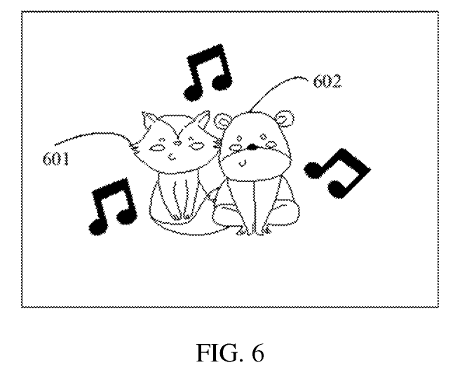

That the first pet character and the second pet character perform the inter-specific intimate interaction behavior is displayed based on that the first pet character and the second pet character belong to different species, and that the relationship between the species of the first pet character and the species of the second pet character is an intimate relationship. For example, the inter-specific intimate interaction behavior includes, but is not limited to, an intimate interaction behavior and an accompanying action interaction behavior. FIG. 6 is a schematic diagram of display of a first pet character and a second pet character performing an intimate interaction behavior according to an example of this application. The first pet character 601 and the second pet character 602 are intimately interacting.

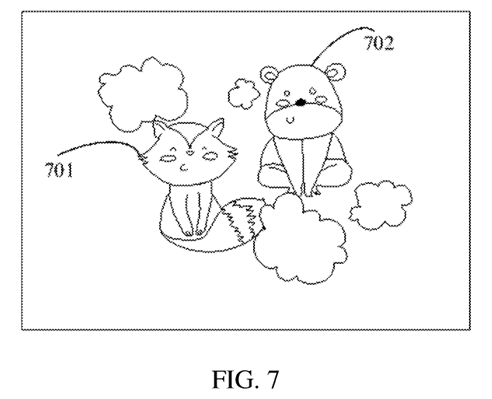

That the first pet character and the second pet character perform the inter-specific hostile interaction behavior is displayed based on that the first pet character and the second pet character belong to different species, and that the relationship between the species of the first pet character and the species of the second pet character is a hostile relationship. For example, the inter-specific hostile interaction behavior includes, but is not limited to, a mutual brawling interaction behavior and a chasing interaction behavior. FIG. 7 is a schematic diagram of display of a first pet character and a second pet character performing an interactive brawling interaction behavior according to an example of this application. The first pet character 701 and the second pet character 702 are mutually brawling.

When the first pet character and the second pet character belong to different species, the relationship between the species of the first pet character and the species of the second pet character may further be classified into an intimate relationship and a hostile relationship. In different cases in which the relationships between the species of the first pet character and the species of the second pet character are the intimate relationship and the hostile relationship, inter-specific interaction behaviors performed by the first pet character and the second pet character are different, and the inter-specific interaction behaviors that can be performed by the first pet character and the second pet character are relatively abundant. This helps improve a display effect of the inter-specific interaction behavior performed by the first pet character and the second pet character, thereby improving interaction experience and increasing an interaction rate.

In this operation, that the first pet character and the second pet character perform the species interaction behavior is displayed to enable a game object to learn the relationship between the first pet character and the second pet character, so that the game object determines whether to attack the first pet character or the second pet character, that is, the game object determines whether to control the virtual player character to enter the turn-based combat state. The game object determines whether to launch an attack, thereby enabling the game object to gain higher controllability on the client (for example, a game).

A manner in which a pet character in the client (for example, a game) receives a group event may be any one of the following.

1. The pet character receives a group event in particular weather.

The particular weather may be any weather. This is not limited in this example of this application. For example, the particular weather is stormy weather.

2. The pet character receives a group event at a particular time.

The particular time may be any time. This is not limited in this example of this application. For example, the particular time is 20:00 every day.

3. The pet character receives a group event after a target interval.

The target interval is set based on experience or adjusted based on an implementation environment. This is not limited in this example of this application. For example, the target interval is four hours, that is, the pet character receives a group event every four hours.

4. The pet character receives a group event after a target event.

The target event may be any event. This is not limited in this example of this application. For example, the target event is that a pet character of a new species appear in the client (for example, a game).

5. There is a random probability that the pet character receives a group event at a current time.

The random probability is set based on experience or adjusted based on an implementation environment. This is not limited in this example of this application. For example, the random probability is 80%, that is, the pet character has an 80% probability of receiving the group event at the current time.

A random probability of the pet character at each time may be the same or different. This is not limited in this example of this application.

When the first pet character and the second pet character receives no group event, the first pet character and the second pet character do not perform the species interaction behavior.

The virtual world-based interaction method provided in this example of this application includes a behavior group. The behavior group is a behavioral implementation for pet characters in the client (for example, a game). Various pet characters are configured for performing specific behaviors in specific conditions, and a formed condition-behavior set is a behavior group. The behavior group includes three parts: a group configuration, a group event, and group behavior rewriting.

The group configuration is a bottom-layer configuration of the behavior group. A species to which each pet character belongs and a character of each pet character in the species to which each pet character belongs are pre-configured in the group configuration. The group configuration specifies an interaction behavior that is to be performed by each pet character after the group event is received. After the pet character receives the group event, the pet character performs the group behavior rewriting, that is, the pet character performs an interaction behavior that is to be performed by the pet character.

For example, the group configuration specifies that after receiving a group event, a pet character whose species is a cat performs a mutual brawling interaction behavior when meeting a pet character whose species is a dog. Therefore, after receiving the group event, if meeting the pet character whose species is a dog in a virtual world, the pet character whose species is a cat performs a mutual brawling interaction behavior with the pet character. In some examples, the mutual brawling interaction behavior may alternatively be referred to as an interactive brawling interaction behavior.

The group event is a driving rule of the behavior group. The group event is configured in an individual behavior tree of a pet character. The group event is triggered in a particular scene. Such a scene includes: a random probability, a daily interval, a stress response, weather at a particular time, and the like. After the group event is triggered, after receiving the group event, a pet character performs an interaction behavior that is to be performed by the pet character.

The group behavior rewriting is a final representation of the behavior group. Each pet character in the client (for example, a game) has an individual behavior representation, and is driven by a state machine and an individual behavior group. However, after receiving the group event, the pet character performs an interaction behavior that is to be performed by the pet character, and the individual behavior group of the pet character is covered. The pet character performs different representations based on different characters of the pet character in a species.

Operation 203: Control, in response to a combat trigger event, a virtual player character to switch from a virtual world exploration state to a turn-based combat state, and control the first pet character and the second pet character to enter the turn-based combat state in a combat mode corresponding to the species interaction behavior.

In a possible implementation, in response to the combat trigger event when the species interaction behavior between the first pet character and the second pet character is an intra-specific interaction behavior or an inter-specific intimate interaction behavior, the virtual player character is controlled to switch from the virtual world exploration state to the turn-based combat state, and the first pet character and the second pet character are controlled to enter the turn-based combat state in a first combat mode, the first combat mode being configured for indicating that the first pet character and the second pet character attack the virtual player character when the virtual player character attacks the first pet character or the second pet character.

The first combat mode is configured for instructing the first pet character and the second pet character to attack the virtual player character when the virtual player character attacks the first pet character or the second pet character. That is, in the possible implementation, after the virtual player character, the first pet character, and the second pet character enter the turn-based combat state, when the virtual player character attacks the first pet character, the first pet character and the second pet character attack the virtual player character together. When the virtual player character attacks the second pet character, the first pet character and the second pet character attack the virtual player character together. A turn-based combat between the virtual player character and the first pet character, and between the virtual player character and the second pet character is a one-to-many turn-based combat. The virtual player character needs to defeat the first pet character and the second pet character to achieve a victory in the turn-based combat.

When the species interaction behavior between the first pet character and the second pet character is an intra-specific interaction behavior or an inter-specific intimate interaction behavior, the virtual player character and pet characters perform a turn-based combat in a one-to-many manner. The manner of performing the turn-based combat by the virtual player character and the pet characters closely matches a relationship between species of the pet characters. This helps improve a visual effect of the turn-based combat performed by the virtual player character and the pet characters, thereby improving interaction experience and increasing an interaction rate.

In another possible implementation, when the species interaction behavior between the first pet character and the second pet character is an inter-specific intimate interaction behavior, in response to the combat trigger event, the virtual player character is controlled to enter the turn-based combat state from the virtual world exploration state, and the first pet character and the second pet character are controlled to enter the turn-based combat state in a second combat mode.

The second combat mode is configured for instructing a target pet character to attack the virtual player character when the virtual player character attacks the target pet character. The target pet character is the first pet character or the second pet character. That is, in the possible implementation, after the virtual player character, the first pet character, and the second pet character enter the turn-based combat state, when the virtual player character attacks the first pet character, the first pet character attacks the virtual player character, and the second pet character does not attack the virtual player character. When the virtual player character attacks the second pet character, the second pet character attacks the virtual player character, and the first pet character does not attack the virtual player character. A turn-based combat between the virtual player character and the first pet character and between the virtual player character and the second pet character is a one-to-one-to-one turn-based combat. The virtual player character needs to defeat the first pet character and the second pet character to achieve a victory in the turn-based combat.

In another possible implementation, when the species interaction behavior between the first pet character and the second pet character is an inter-specific hostile interaction behavior, in response to the combat trigger event, the virtual player character is controlled to enter the turn-based combat state from the virtual world exploration state, and the first pet character and the second pet character are controlled to enter the turn-based combat state in a second combat mode. The second combat mode is configured for instructing a target pet character to attack the virtual player character when the virtual player character attacks the target pet character. The target pet character is the first pet character or the second pet character.

In some examples, the species interaction behavior between the first pet character and the second pet character being an inter-specific hostile interaction behavior occurs on the premise that the first pet character and the second pet character belong to different species, and that the relationship between the species of the first pet character and the species of the second pet character is a hostile relationship. Based on this, when the first pet character and the second pet character belong to different species, and the relationship between the species of the first pet character and the species of the second pet character is the hostile relationship, in response to the combat trigger event, the virtual player character is controlled to switch from the virtual world exploration state to the turn-based combat state, and the first pet character and the second pet character are controlled to enter the turn-based combat state in the second combat mode.

After the virtual player character enters the turn-based combat state, and the first pet character and the second pet character enter the turn-based combat state in the second combat mode, when the virtual player character attacks the first pet character, the first pet character attacks the virtual player character and the second pet character does not attack the virtual player character. When the virtual player character attacks the second pet character, the second pet character attacks the virtual player character, and the first pet character does not attack the virtual player character. A turn-based combat between the virtual player character and the first pet character and between the virtual player character and the second pet character is a one-to-one-to-one turn-based combat. The virtual player character needs to defeat the first pet character and the second pet character to achieve a victory in the turn-based combat.

When the species interaction behavior between the first pet character and the second pet character is an inter-specific hostile interaction behavior, the virtual player character and pet characters perform a turn-based combat in a one-to-one-to-one manner. A manner of performing the turn-based combat by the virtual player character and the pet characters closely matches a relationship between species of the pet characters. This helps improve a visual effect of the turn-based combat performed by the virtual player character and the pet characters, thereby improving interaction experience and increasing an interaction rate.

In a possible implementation, the combat trigger event is triggered in response to that an ally pet character corresponding to the virtual player character is summoned. When the ally pet character corresponding to the virtual player character is summoned, the combat trigger event is automatically triggered, providing convenient triggering of the combat trigger event. This helps improve interaction experience and increasing an interaction rate.

For example, manners of summoning the ally pet character corresponding to the virtual player character include, but are not limited to, the following two manners.

Manner 1: Display a summoning control, where the summoning control is configured to trigger a summoning function. Based on that the summoning function is triggered, the ally pet character is summoned.

In one example, a summoning control is displayed in an interaction interface. For example, a summoning control is displayed in a game interaction interface. For example, 304 in FIG. 3 is a summoning control. In response to receiving a selection operation on the summoning control, the summoning function is triggered. The selection operation on the summoning control may be a click operation on the summoning control. Certainly, the selection operation on the summoning control may alternatively be another operation. This is not limited in this example of this application.

In the manner 1, by triggering the summoning control, the ally pet character may be summoned by means of one click, so that a manner of summoning the ally pet character is relatively simple, and interaction efficiency is relatively high.

The manner 1 is described by using only an example in which the summoning function is triggered by triggering the summoning control. This example of this application is not limited thereto. The summoning function may further be triggered in another manner. In some examples, a manner of triggering the summoning function may further be: triggering the summoning function in response to detecting a summoning voice. The summoning voice is a voice configured for triggering the summoning function. The summoning voice may be set based on experience or adjusted based on an implementation environment. This is not limited in this example of this application. In some other examples, a manner of triggering the summoning function may further be: triggering the summoning function in response to detecting a summoning gesture. The summoning gesture is a gesture configured for triggering the summoning function. The summoning gesture may be set based on experience or adjusted based on an implementation environment. This is not limited in this example of this application. In some other examples, a manner of triggering the summoning function may further be: triggering the summoning function in response to detecting a summoning operation in a handle. The summoning operation is an operation configured for triggering the summoning function. The summoning operation may be set based on experience or adjusted based on an implementation environment. This is not limited in this example of this application. The handle is a controller used by a game object to perform a human-computer interaction with a terminal device. The game object can control, by using a component such as a joystick, a key, or a safety latch in the handle, the virtual player character to move in the virtual world.

Manner 2: Summon the ally pet character based on an operation of controlling the virtual player character to move toward the target pet character and that a distance between the virtual player character and the target pet character is less than a distance threshold, the target pet character being the first pet character or the second pet character.

The distance threshold is set based on experience or adjusted based on an implementation environment. This is not limited in this example of this application. For example, the distance threshold is 1 meter.

In a possible implementation, a movement control is further displayed in an interaction interface. For example, a movement control is further displayed in a game interaction interface, and the movement control is configured to control the virtual player character to move. For example, 305 in FIG. 3 is a movement control. In response to a slide-up operation on the movement control, the virtual player character is controlled to move forward. In response to a slide-down operation on the movement control, the virtual player character is controlled to move backward. In response to a slide-left operation on the movement control, the virtual player character is controlled to move leftward. In response to a slide-right operation on the movement control, the virtual player character is controlled to move rightward. In response to a sliding operation on the movement control in another direction, the virtual player character is controlled to move in another direction. The another direction is not limited in this example of this application.

In the manner 2, the ally pet character is summoned in a process of moving the virtual player character, so that manners of summoning the ally pet character are diversified, and the summoning manners are more flexible.

Any one of the foregoing manners may be selected to summon the ally pet character. This is also not limited in this example of this application.

In a possible implementation, the ally pet character is displayed at a first position in response to that the ally pet character corresponding to the virtual player character is summoned, the first position being located in a second direction of the virtual player character, and a distance between the first position and the virtual player character being a second distance. For example, the second direction is a horizontal direction, the horizontal direction includes a left direction and a right direction, and the second direction may be a left direction or a right direction. This is not limited in this example of this application. The second distance is set based on experience or adjusted based on an implementation environment. This is also not limited in this example of this application. For example, the second distance is 10 centimeters.

In the implementation, the ally pet character is displayed at the first position, so that the game object determines that the ally pet character of the virtual player character is already summoned, and the virtual player character already switches from the virtual world exploration state to the turn-based combat state, thereby facilitating the game object determining game progress.

In a possible implementation, attribute information corresponding to the ally pet character is displayed in response to that the ally pet character corresponding to the virtual player character is summoned, the attribute information corresponding to the ally pet character being configured for indicating a remaining attribute value of the ally pet character and an attribute threshold of the ally pet character. A manner of representing the attribute information corresponding to the ally pet character is not limited in this example of this application. In some examples, the attribute information corresponding to the ally pet character may be represented by an attribute bar corresponding to the ally pet character. In such a case, the attribute bar corresponding to the ally pet character is displayed in response to that the ally pet character corresponding to the virtual player character is summoned, the attribute bar corresponding to the ally pet character being configured for indicating the remaining attribute value of the ally pet character and the attribute threshold of the ally pet character. In the implementation, the attribute bar corresponding to the ally pet character is displayed, so that the game object determines the remaining attribute value of the ally pet character, and the game object has an understanding of a combat capacity of the ally pet character.

In one example, the attribute bar corresponding to the ally pet character includes a remaining attribute bar corresponding to the ally pet character and an attribute threshold bar corresponding to the ally pet character. The remaining attribute bar corresponding to the ally pet character is configured for indicating the remaining attribute value of the ally pet character, and the attribute threshold bar corresponding to the ally pet character is configured for indicating the attribute threshold of the ally pet character.

For example, the attribute threshold of the ally pet character is a largest attribute value of the ally pet character. The attribute threshold of the ally pet character is set based on experience or adjusted based on an implementation environment. This is not limited in this example of this application. For example, the attribute threshold of the ally pet character is 100. The remaining attribute value that is of the ally pet character and that is indicated by the attribute bar of the ally pet character is a remaining attribute value of the ally pet character before the ally pet character is summoned. For example, if the remaining attribute value of the ally pet character before the ally pet character is summoned is 80, the remaining attribute value that is of the ally pet character and that is indicated by the attribute bar of the ally pet character is 80.

In some examples, the attribute information corresponding to the ally pet character may alternatively be represented in another manner other than by using the attribute bar corresponding to the ally pet character, provided that the remaining attribute value of the ally pet character and the attribute threshold of the ally pet character can be indicated. For example, the attribute information corresponding to the ally pet character may be represented by using an attribute text box corresponding to the ally pet character. The attribute text box corresponding to the ally pet character includes text configured for recording the remaining attribute value of the ally pet character and text configured for recording the attribute threshold of the ally pet character. For another example, the attribute information corresponding to the ally pet character may further be represented by using an attribute table corresponding to the ally pet character. The attribute table corresponding to the ally pet character includes a cell configured for recording the remaining attribute value of the ally pet character and a cell configured for recording the attribute threshold of the ally pet character.

In a possible implementation, attribute information corresponding to the first pet character and attribute information corresponding to the second pet character are displayed in response to that the first pet character and the second pet character enter the turn-based combat state, the attribute information corresponding to the first pet character being configured for indicating a remaining attribute value of the first pet character and an attribute threshold of the first pet character, and the attribute information corresponding to the second pet character being configured for indicating a remaining attribute value of the second pet character and an attribute threshold of the second pet character. A manner of representing the attribute information corresponding to the first pet character and the attribute information corresponding to the second pet character is not limited in this example of this application. In some examples, the attribute information corresponding to the first pet character may be represented by using an attribute bar corresponding to the first pet character, and the attribute information corresponding to the second pet character may be represented by using an attribute bar corresponding to the second pet character. In this case, in response to that the first pet character and the second pet character enter the turn-based combat state, the attribute bar corresponding to the first pet character and the attribute bar corresponding to the second pet character may further be displayed. The attribute bar corresponding to the first pet character is configured for indicating the remaining attribute value of the first pet character and the attribute threshold of the first pet character. The attribute bar corresponding to the second pet character is configured for indicating the remaining attribute value of the second pet character and the attribute threshold of the second pet character. In the implementation, the attribute bars respectively corresponding to the first pet character and the second pet character are displayed, so that the game object determines the remaining attribute value of the first pet character and the remaining attribute value of the second pet character, and the game object has an understanding of a combat capacity of the first pet character and a combat capacity of the second pet character.

In one example, the attribute bar corresponding to the first pet character include a remaining attribute bar corresponding to the first pet character and an attribute threshold bar corresponding to the first pet character. The remaining attribute bar corresponding to the first pet character is configured for indicating the remaining attribute value of the first pet character, and the attribute threshold bar corresponding to the first pet character is configured for indicating the attribute threshold of the first pet character.

For example, the attribute threshold of the first pet character is a largest attribute value of the first pet character. The attribute threshold of the first pet character is set based on experience or adjusted based on an implementation environment. This is not limited in this example of this application. For example, the attribute threshold of the first pet character is 100.

For example, the remaining attribute value that is of the first pet character and that is indicated by the attribute information corresponding to the first pet character is a remaining attribute value of the first pet character before the first pet character enters the turn-based combat state. Based on this, after entering the turn-based combat state, the first pet character can maintain the attribute value used before the first pet character enters the turn-based combat state, to reduce a disconnection between the first pet character before the turn-based combat state is entered and the first pet character after the turn-based combat state is entered, thereby helping improve interaction experience and increasing an interaction rate. When the attribute information corresponding to the first pet character is represented by the attribute bar corresponding to the first pet character, the remaining attribute value that is of the first pet character and that is indicated by the attribute bar corresponding to the first pet character is the remaining attribute value of the first pet character before the first pet character enters the turn-based combat state. For example, if the remaining attribute value of the first pet character before the first pet character enters the turn-based combat state is 70, the remaining attribute value that is of the first pet character and that is indicated by the attribute bar of the first pet character is 70. That is, when the first pet character is injured in a combat with another pet character before entering the turn-based combat state, the first pet character maintains an injured state after entering the turn-based combat state.

Similarly, the attribute bar corresponding to the second pet character include a remaining attribute bar corresponding to the second pet character and an attribute threshold bar corresponding to the second pet character. The remaining attribute bar corresponding to the second pet character is configured for indicating the remaining attribute value of the second pet character, and the attribute threshold bar corresponding to the second pet character is configured for indicating the attribute threshold of the second pet character.

For example, the attribute threshold of the second pet character is a largest attribute value of the second pet character. The attribute threshold of the second pet character is set based on experience or adjusted based on an implementation environment. This is not limited in this example of this application. For example, the attribute threshold of the second pet character is 100.

For example, the remaining attribute value that is of the second pet character and that is indicated by the attribute information corresponding to the second pet character is a remaining attribute value of the second pet character before the second pet character enters the turn-based combat state. Based on this, after entering the turn-based combat state, the second pet character can maintain the attribute value used before the second pet character enters the turn-based combat state, to reduce a disconnection between the second pet character before the turn-based combat state is entered and the second pet character after the turn-based combat state is entered, thereby helping improve interaction experience and increasing an interaction rate. When the attribute information corresponding to the second pet character is represented by the attribute bar corresponding to the second pet character, the remaining attribute value that is of the second pet character and that is indicated by the attribute bar corresponding to the second pet character is the remaining attribute value of the second pet character before the second pet character enters the turn-based combat state. For example, if the remaining attribute value of the second pet character before the second pet character enters the turn-based combat state is 70, the remaining attribute value that is of the second pet character and that is indicated by the attribute bar of the second pet character is 70. That is, when the second pet character is injured in a combat with another pet character before entering the turn-based combat state, the second pet character maintains an injured state after entering the turn-based combat state.

In some examples, the attribute information corresponding to the first pet character may alternatively be represented in another manner other than by using the attribute bar corresponding to the first pet character, provided that the remaining attribute value of the first pet character and the attribute threshold of the first pet character can be indicated. For example, the attribute information corresponding to the first pet character may be represented by using an attribute text box corresponding to the first pet character. The attribute text box corresponding to the first pet character includes text configured for recording the remaining attribute value of the first pet character and text configured for recording the attribute threshold of the first pet character. For another example, the attribute information corresponding to the first pet character may further be represented by using an attribute table corresponding to the first pet character. The attribute table corresponding to the first pet character includes a cell configured for recording the remaining attribute value of the first pet character and a cell configured for recording the attribute threshold of the first pet character.

The attribute information corresponding to the second pet character may alternatively be represented in another manner other than by using the attribute bar corresponding to the second pet character, provided that the remaining attribute value of the second pet character and the attribute threshold of the second pet character can be indicated. For example, the attribute information corresponding to the second pet character may be represented by using an attribute text box corresponding to the second pet character. The attribute text box corresponding to the second pet character includes text configured for recording the remaining attribute value of the second pet character and text configured for recording the attribute threshold of the second pet character. For another example, the attribute information corresponding to the second pet character may further be represented by using an attribute table corresponding to the second pet character. The attribute table corresponding to the second pet character includes a cell configured for recording the remaining attribute value of the second pet character and a cell configured for recording the attribute threshold of the second pet character.

In a possible implementation, a target identifier is displayed when the target pet character enters the turn-based combat state, based on that a remaining attribute value of the target pet character before the target pet character enters the turn-based combat state is less than an attribute threshold of the target pet character, the target identifier being configured for indicating that the target pet character is injured, and the target pet character being the first pet character or the second pet character. In this manner, the game object may determine that the target pet character is injured before entering a turn-based combat.

In one example, the target identifier is displayed near the target pet character. Being near the target pet character may be above, below, in front of, or behind the target pet character. This is not limited in this example of this application. The target identifier may be any identifier. This is not limited in this example of this application.

In some examples, the target identifier may alternatively be referred to as an injury identifier. In other words, when the target pet character enters the turn-based combat state, the injury identifier is displayed based on that the remaining attribute value of the target pet character before the target pet character enters the turn-based state is less than the attribute threshold of the target pet character. The injury identifier is configured for indicating that the target pet character is injured.

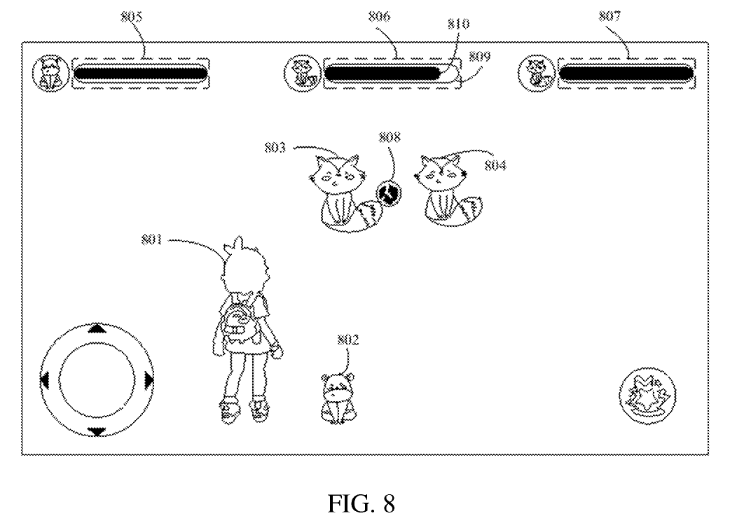

FIG. 8 is a schematic diagram of display of another game interaction interface according to an example of this application. A virtual player character 801, an ally pet character 802 of the virtual player character 801, a first pet character 803, a second pet character 804, an attribute bar 805 corresponding to the ally pet character 802, an attribute bar 806 corresponding to the first pet character 803, and an attribute bar 807 corresponding to the second pet character 804 are displayed. Because the first pet character 803 is injured before entering a turn-based combat state, a target identifier 808 of the first pet character 803 is displayed.

The attribute bar 806 corresponding to the first pet character 803 is used as an example, and includes a remaining attribute bar 810 of the first pet character and an attribute threshold bar 809 of the first pet character.

After the virtual player character, the first pet character, and the second pet character enter the turn-based combat state, instructions are sequentially settled based on a sequence of the instructions of the virtual player character, the first pet character, and the second pet character. For example, when the virtual player character first transmits an attack instruction to the first pet character, the virtual player character first attacks the first pet character.

In a possible implementation, in response to that the first pet character enters the turn-based combat state, a third pet character may further be called to enter the turn-based combat state. The third pet character and the first pet character belong to the same species, or the third pet character and the first pet character belong to different species and a relationship between the species of the third pet character and the species of the first pet character is an intimate relationship. After the third pet character enters the turn-based combat state, the third pet character may help the first pet character. In other words, in a turn-based combat, whoever attacks the first pet character is attacked by the third pet character. In this way, a combat capacity of the first pet character can be increased, to help the first pet character achieve a victory in the turn-based combat.

A process of calling the third pet character to enter the turn-based combat state includes: determining the third pet character in response to that the first pet character enters the turn-based combat state; and controlling the third pet character to enter the turn-based combat state, the third pet character being configured for helping the first pet character.

A manner of determining the third pet character is not limited in this example of this application. In one example, a process of determining the third pet character includes: determining a target area based on current position information of the first pet character in response to that the first pet character enters the turn-based combat state; determining first candidate pet characters located in the target area; and determining the third pet character from the first candidate pet characters. In the implementation, the third pet character is determined from pet characters relatively close to the first pet character. In this way, the third pet character can quickly reach a side of the first pet character, so that the third pet character can quickly support the first pet character.

For example, a process of determining the target area based on the current location information of the first pet character includes: determining the target area based on a target length by using, as a center, a position indicated by the current position information of the first pet character. In one example, the target area is determined by using, as a center of a circle, the position indicated by the current position information of the first pet character and the target length as a radius. The target length is set based on experience or adjusted based on an implementation environment. The target length is not limited in this example of this application. For example, the target length is 10 meters.

In some examples, the target area may alternatively be referred to as a candidate area. In other words, the candidate area is determined based on the current position information of the first pet character in response to that the first pet character enters the turn-based combat state; first candidate pet characters located in the candidate area are determined; and the third pet character is determined from the first candidate pet characters.

In an example, a process of determining the third pet character from the first candidate pet characters includes: determining second candidate pet characters from the first candidate pet characters, the second candidate pet character and the first pet character belonging to the same species, or the second candidate pet character and the first pet character belonging to different species and a relationship between the species of the second candidate pet character and the species of the first pet character being an intimate relationship; and determining the third pet character from the second candidate pet characters. First, the second candidate pet characters that have a proper relationship with the species of the first pet character are screened out from the first candidate pet characters, and then the third pet character is determined from the second candidate pet characters. This helps ensure reliability of the finally determined third pet character.

A manner of determining the third pet character from the second candidate pet characters is not limited in this example of this application. In one example, this example of this application provides the following two implementations of determining the third pet character from the second candidate pet characters.

Implementation 1: Determine the second candidate pet character as the third pet character.

In the implementation 1, all the second candidate pet characters in the target area are used as third pet characters. In this way, all the second candidate pet characters located in the target area support the first pet character, thereby increasing a probability that the first pet character achieves a victory in a turn-based combat.

Implementation 2: Determine a distance between each of the second candidate pet characters and the first pet character; sort each of the second candidate pet characters in a target sequence based on the distance between each of the second candidate pet characters and the first pet character, to obtain a sorting list; and determine a second candidate pet character located before a target position in the sorting list as the third pet character.

The target sequence may be an ascending sequence or a descending sequence. This is not limited in this example of this application. The target position is set based on experience or adjusted based on an implementation environment. This is not limited in this example of this application. For example, the target position is a third position. That is, first two second candidate pet characters in the sorting list are used as third pet characters.

For example, there are eight second candidate pet characters, namely, a second candidate pet character 1 to a second candidate pet character 8. The second candidate pet characters are sorted in ascending order of distances between the second candidate pet characters and the first pet character, and an obtained sorting list is: the second candidate pet character 1, the second candidate pet character 8, the second candidate pet character 2, the second candidate pet character 7, the second candidate pet character 3, the second candidate pet character 6, the second candidate pet character 4, and the second candidate pet character 5. The second candidate pet characters located in front of the third position in the sorting list are used as the third pet characters. That is, the first two second candidate pet characters in the sorting list are used as the third pet characters. Therefore, the determined third pet characters are the second candidate pet character 1 and the second candidate pet character 8.

In some examples, the target sequence may alternatively be referred to as a reference sequence, the target position may alternatively be referred to as a reference position, and in this case, each of the second candidate pet characters is sorted in the reference sequence based on the distance between each of the second candidate pet characters and first pet character, to obtain a sorting list; and a second candidate pet character located before the reference position in the sorting list is determined as the third pet character.

In the implementation 2, some of all the second candidate pet characters are used as the third pet characters. In this way, a quantity of third pet characters supporting the first pet character may be restricted, thereby ensuring fairness of the turn-based combat.

In a possible implementation, after the third pet character is determined, the third pet character may further be displayed. A process of displaying the third pet character is as follows: displaying the third pet character in a first direction of the first pet character, a distance between the third pet character and the first pet character in the first direction being a first distance. In some examples, the first direction may alternatively be referred to as a longitudinal direction.

For example, the first direction of the first pet character is being in front of or being behind the first pet character. In this example of this application, that the first direction of the first pet character is being behind the first pet character is used as an example. The first distance is set based on experience or adjusted based on an implementation environment. This is not limited in this example of this application. For example, the first distance is 5 centimeters. That is, a distance that is between a display position of the third pet character and a display position of the first pet character and that is in the longitudinal direction is 5 centimeters.

After the third pet character is summoned, the third pet character is displayed behind the first pet character in the foregoing display manner, so that the third pet character is not mistakenly injured when the first pet character attacks another object. In addition, the first pet character and the third pet character are relatively beautifully arranged and an image display effect is better, thereby helping improve visual experience of a game object and further increasing an interaction rate.

A reference pet character may further be determined in response to that the second pet character enters the turn-based combat state; and the reference pet character is controlled to enter the turn-based combat state, the reference pet character being configured for helping the second pet character. The reference pet character and the second pet character belong to the same species, or the reference pet character and the second pet character belong to different species and a relationship between the species of the reference pet character and the species of the second pet character is an intimate relationship. After the reference pet character is determined, the reference pet character is displayed in a first direction of the second pet character, and a distance that is between the reference pet character and the second pet character and that is in the first direction (which may alternatively be referred to as a longitudinal direction) is a first distance. A manner of determining the reference pet character is similar to the manner of determining the third pet character, and details are not described herein again in this example of this application.

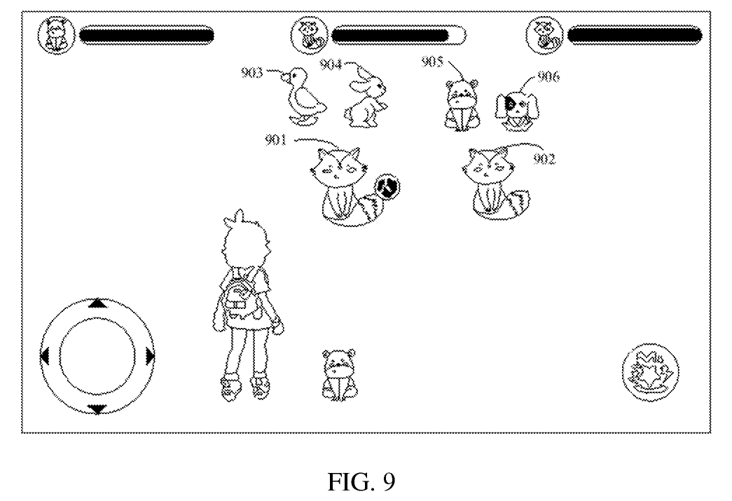

For example, when the first pet character and the second pet character enter a turn-based combat, two third pet characters and two reference pet characters are determined, the two third pet characters are displayed behind the first pet character, and the two reference pet characters are displayed behind the second pet character. FIG. 9 is a schematic diagram of display of a third pet character and a reference pet character according to an example of this application. A first pet character 901, a second pet character 902, third pet characters 903 and 904, and reference pet characters 905 and 906 are displayed. The third pet characters 903 and 904 are located behind the first pet character 901, and a distance that is between the third pet characters 903 and 904 and the first pet character 901 and that is in a longitudinal direction is a first distance. The reference pet characters 905 and 906 are located behind the second pet character 902, and a distance that is between the reference pet characters 905 and 906 and the second pet character 902 and that is in a longitudinal direction is a first distance.

In a possible implementation, when the first pet character and the second pet character enter a turn-based combat state, in a turn-based combat, a virtual player character may attack either of the first pet character and the second pet character by using an ally pet character, and cannot attack the third pet character located behind the first pet character or the reference pet character located behind the second pet character.

When the first pet character and the second pet character enter the turn-based combat state in a first combat mode, in a turn-based combat, when the virtual player character attacks a target pet character by using the ally pet character, the first pet character and the second pet character attack the ally pet character. In one example, the first pet character and the second pet character may attack the ally pet character at the same time, or the first pet character may attack the ally pet character before the second pet character attacks the ally pet character, or the second pet character may attack the ally pet character before the first pet character attacks the ally pet character. That is, each turn of the turn-based combat includes an action of attacking the target pet character by one target pet character and an action of attacking the ally pet character by two target pet characters.

In one example, an animation in which the third pet character executes a first interaction action is displayed based on that the first pet character attacks the ally pet character; and an animation in which the third pet character executes a second interaction action is displayed based on that the virtual player character attacks the first pet character by using the ally pet character, the second interaction action being different from the first interaction action. For example, the first interaction action is a joyful cheering action, and the second interaction action is a sorrowful action. A game object learns a current combat situation by controlling a pet character located in a rear row to execute an interaction action, thereby enhancing controllability of the game object over a game.

Similarly, an animation in which the reference pet character executes the first interaction action is displayed based on that the second pet character attacks the ally pet character; and an animation in which the reference pet character executes the second interaction action is displayed based on that the virtual player character attacks the second pet character by using the ally pet character.

In a possible implementation, when the first pet character and the second pet character enter the turn-based combat state in the first combat mode, based on that the first pet character attacks the ally pet character, the animation in which the reference pet character executes the first interaction action may further be displayed; and the animation in which the reference pet character executes the second interaction action is displayed based on that the virtual player character attacks the first pet character by using the ally pet character. An animation in which the third pet character executes the first interaction action is displayed based on that the second pet character attacks the ally pet character; and an animation in which the third pet character executes the second interaction action is displayed based on that the virtual player character attacks the second pet character by using the ally pet character,

In another possible implementation, the third pet character may further apply a skill to the first pet character, to increase an attacking force of the first pet character or to increase a life value of the first pet character. The reference pet character may further apply a skill to the second pet character, to increase an attacking force of the second pet character or to increase a life value of the second pet character. Both a manner of applying the skill to the first pet character by the third pet character and a manner of applying the skill to the second pet character by the reference pet character are not limited in this example of this application.

The third pet character and a fourth pet character that is among the reference pet character are displayed at a position of the first pet character when the first pet character and the second pet character enter the turn-based combat state in the first combat mode and an attribute value of the first pet character is less than a target value. The fourth pet character is either of the third pet character and the reference pet character, the fourth pet character is a pet character that is among the third pet character and the reference pet character and that is closest to the first pet character, the fourth pet character is a pet character that is among the third pet character and the reference pet character and that is farthest from the first pet character, the fourth pet character is a pet character that is among the third pet character and the reference pet character and that has a largest remaining attribute value, or the fourth pet character is a pet character that is among the third pet character and the reference pet character and that has a smallest remaining attribute value.

The target value is set based on experience or adjusted based on an implementation environment. This is not limited in this example of this application. For example, the target value is 1.

After the fourth pet character is displayed at the position of the first pet character, an attribute bar corresponding to the fourth pet character is displayed at a display position of the attribute bar corresponding to the first pet character, the attribute bar corresponding to the fourth pet character being configured for indicating a remaining attribute value of the fourth pet character and an attribute threshold of the fourth pet character.

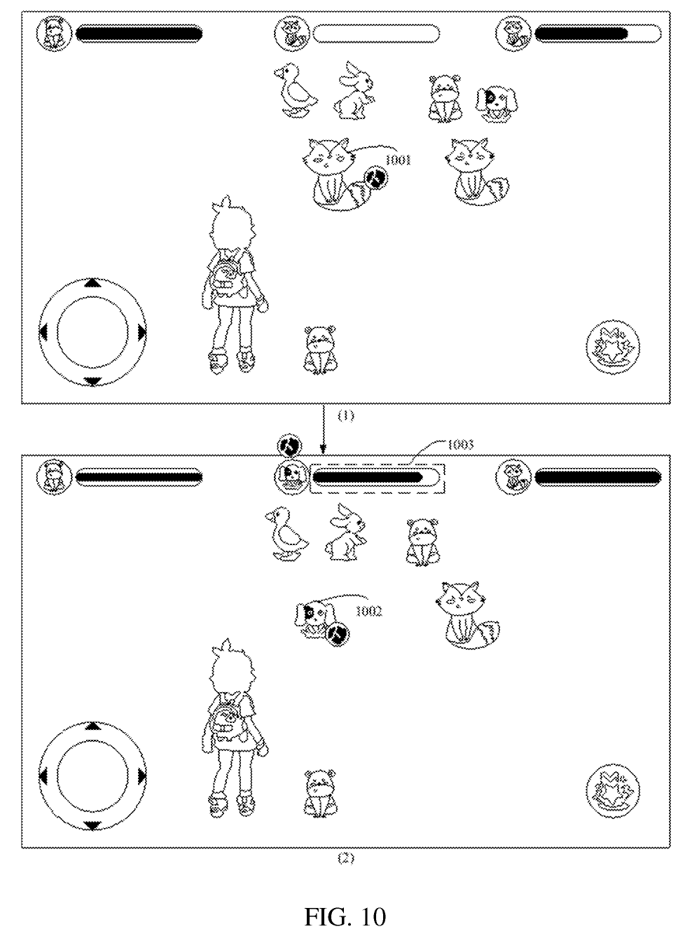

FIG. 10 is a schematic diagram of display of a manner of substituting for a pet character according to an example of this application. In (1) shown in FIG. 10, an attribute value of a first pet character 1001 is less than a target value. In this case, (2) in FIG. 10 is displayed. A third pet character and a fourth pet character 1002 that is among the reference pet character are displayed at a position of the first pet character 1001, and an attribute bar 1003 corresponding to the fourth pet character 1002 is displayed.

The third pet character and a fifth pet character that is among the reference pet character are displayed at a position of a second pet character when the first pet character and the second pet character enter a turn-based combat state in a first combat mode and an attribute value of the second pet character is less than the target value. A manner of determining the fifth pet character is similar to the manner of determining the fourth pet character, and details are not described herein again.

A sixth pet character among the third pet character is displayed at the position of the first pet character when the first pet character and the second pet character enter the turn-based combat state in a second combat mode and the attribute value of the first pet character is less than the target value. The sixth pet character is any one of the third pet character, the sixth pet character is a pet character that is among the third pet character and that is closest to the first pet character, the sixth pet character is a pet character that is among the third pet character and that is farthest from the first pet character, the sixth pet character is a pet character that is among the third pet character and that has a largest remaining attribute value, or the sixth pet character is a pet character that is among the third pet character and that has a smallest remaining attribute value.

After the sixth pet character is displayed at the position of the first pet character, an attribute bar corresponding to the sixth pet character is displayed at a display position of the attribute bar corresponding to the first pet character, the attribute bar corresponding to the sixth pet character being configured for indicating a remaining attribute value of the sixth pet character and an attribute threshold of the sixth pet character.

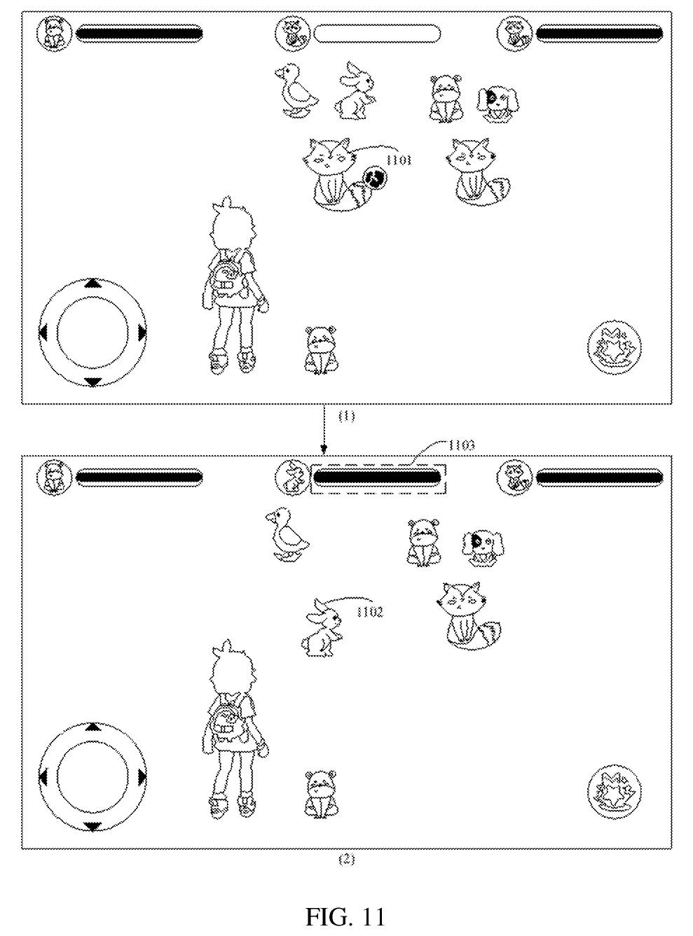

FIG. 11 is a schematic diagram of display of another manner of substituting for a pet character according to an example of this application. In (1) shown in FIG. 11, an attribute value of a first pet character 1101 is less than a target value. In this case, (2) in FIG. 11 is displayed. A sixth pet character 1102 among a third pet character is displayed at a position of the first pet character 1101, and an attribute bar 1103 corresponding to the sixth pet character 1102 is displayed.

A seventh pet character among a reference pet character is displayed at a position of a second pet character when the first pet character and the second pet character enter a turn-based combat state in a second combat mode and an attribute value of the second pet character is less than the target value. A manner of determining the seventh pet character is similar to the foregoing manner of determining the sixth pet character, and details are not described herein again in this example of this application.

In a possible implementation, when the first pet character and the second pet character enter a turn-based combat in the second combat mode, a virtual player character either may stay on a sideline and watch the combat between the first pet character and the second pet character, or may choose to intervene. If the virtual player character does not attack either of the first pet character and the second pet character by using an ally pet character, the first pet character and the second pet character may continue attacking each other, without considering the ally pet character of the virtual player character. If the virtual player character attacks the first pet character by using the ally pet character, the first pet character turns to attack the ally pet character of the virtual player character, but turns back to attack the second pet character in a next turn. However, if the virtual player character continuously attacks the first pet character by using the ally pet character, the first pet character turns to continuously attack the ally pet character.

Regardless of a specific combat mode in which the first pet character and the second pet character enter the turn-based combat state, the virtual player character may achieve a victory in the turn-based combat only after the ally pet character of the virtual player character defeats all pet characters that enter the turn-based combat state.

Based on the foregoing method, when the virtual player character enters the turn-based combat state, the first pet character and the second pet character also enter the turn-based combat state, and the first pet character and the second pet character enter the turn-based combat state in the combat mode corresponding to the species interaction behavior performed by the first pet character and the second pet character before the first pet character and the second pet character enter the turn-based combat state, so that a relationship that is between the first pet character and the second pet character and that exists before the turn-based combat state is entered continues into the turn-based state. The relationship that is between the first pet character and the second pet character and that exists before the turn-based combat state is entered is consistent with a relationship that is between the first pet character and the second pet character and that exists after the turn-based combat state is entered, thereby reducing a disconnection between the relationship existing before the turn-based combat state is entered and the relationship existing after the turn-based combat state is entered, making interaction experience more complete, and improving immersion of a player, so that an interaction rate and a user retention rate can be increased.

In addition, after the virtual player character, the first pet character, and the second pet character enter the turn-based combat state, the virtual player character not only may perform a turn-based combat with the first pet character, but also may perform a turn-based combat with the second pet character, thereby reducing a limitation of an interaction by the virtual player character in a virtual world, making the interaction by the virtual player character in the virtual world more flexible and interaction manners in the virtual world more diversified, and making the interaction funnier, so that an interaction rate and a user retention rate can be increased.

In addition, based on the method provided in the examples of this application, a client can continuously produce various species interaction behaviors and combat modes, so that interaction diversity can be improved, and an interaction rate and a user retention rate are further increased.

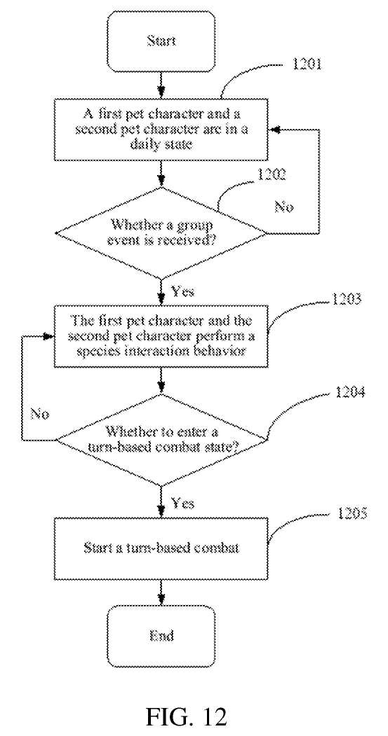

FIG. 12 is a flowchart of a virtual world-based interaction method according to an example of this application. As shown in FIG. 12, a procedure includes the following operation 1201 to operation 1205.

1201: A first pet character and a second pet character are in a daily state.

A pet character in the daily state does not interact with another pet character. Representation of each pet character in the daily state may be the same or different. This is not limited in this example of this application.

1202: Determine whether a group event is received.

When the group event is received, operation 1203 is performed. When no group event is received, operation 1201 is performed.

1203: The first pet character and the second pet character perform a species interaction behavior.

The process is described in the foregoing operation 202. For details, refer to the related descriptions in the foregoing operation 202. Details are not described herein again.

1204: Determine whether the first pet character and the second pet character enter a turn-based combat state.

Operation 1205 is performed when the first pet character and the second pet character enter the turn-based combat state; and operation 1203 is performed when the first pet character and the second pet character do not enter the turn-based combat state.

1205: Start a turn-based combat.

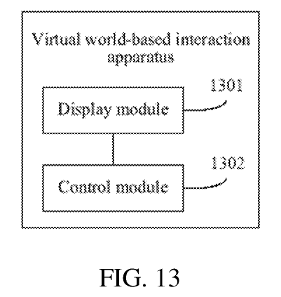

FIG. 13 is a schematic diagram of a structure of a virtual world-based interaction apparatus according to an example of this application. As shown in FIG. 13, the apparatus includes: a display module 1301, configured to display a first pet character and a second pet character that are in a virtual world, the first pet character and the second pet character belonging to the same species or different species, and the display module 1301 being further configured to display that the first pet character and the second pet character perform a species interaction behavior; and a control module 1302, configured to control, in response to a combat trigger event, a virtual player character to switch from a virtual world exploration state to a turn-based combat state, and control the first pet character and the second pet character to enter the turn-based combat state in a combat mode corresponding to the species interaction behavior.

In a possible implementation, the species interaction behavior includes an intra-specific interaction behavior; and the display module 1301 is configured to display, based on that the first pet character and the second pet character belong to the same species, that the first pet character and the second pet character perform the intra-specific interaction behavior.

In a possible implementation, the control module 1302 is configured to: in response to the combat trigger event when the species interaction behavior between the first pet character and the second pet character is an intra-specific interaction behavior or an inter-specific intimate interaction behavior, control the virtual player character to switch from the virtual world exploration state to the turn-based combat state, and control the first pet character and the second pet character to enter the turn-based combat state in a first combat mode, the first combat mode being configured for indicating that the first pet character and the second pet character attack the virtual player character when the virtual player character attacks the first pet character or the second pet character.

In a possible implementation, the species interaction behavior includes an inter-specific interaction behavior; and the display module 1301 is configured to display, based on that the first pet character and the second pet character belong to the different species, that the first pet character and the second pet character perform the inter-specific interaction behavior.

In a possible implementation, the inter-specific interaction behavior includes the inter-specific intimate interaction behavior and an inter-specific hostile interaction behavior; and the display module 1301 is configured to display, based on that the first pet character and the second pet character belong to different species, and that a relationship between the species of the first pet character and the species of the second pet character is an intimate relationship, that the first pet character and the second pet character perform the inter-specific intimate interaction behavior; and display, based on that the first pet character and the second pet character belong to different species, and that the relationship between the species of the first pet character and the species of the second pet character is a hostile relationship, that the first pet character and the second pet character perform the inter-specific hostile interaction behavior.

In a possible implementation, the control module 1302 is configured to: in response to the combat trigger event when the first pet character and the second pet character belong to different species, and a relationship between the species of the first pet character and the species of the second pet character is a hostile relationship, control the virtual player character to switch from the virtual world exploration state to the turn-based combat state, and control the first pet character and the second pet character to enter the turn-based combat state in a second combat mode, the second combat mode being configured for indicating that a target pet character attacks the virtual player character when the virtual player character attacks the target pet character, and the target pet character being the first pet character or the second pet character.

In a possible implementation, the apparatus further includes: a determining module, configured to determine a third pet character in response to that the first pet character enters the turn-based combat state, the third pet character and the first pet character belonging to the same species, or the third pet character and the first pet character belonging to different species and a relationship between the species of the third pet character and the species of the first pet character being an intimate relationship; and the control module 1302 being further configured to control the third pet character to enter the turn-based combat state, the third pet character being configured for helping the first pet character.

In a possible implementation, the determining module is configured to determine a candidate area based on current position information of the first pet character in response to that the first pet character enters the turn-based combat state; determine first candidate pet characters located in the candidate area; and determine the third pet character from the first candidate pet characters.

In a possible implementation, the determining module is configured to determine second candidate pet characters from the first candidate pet characters, the second candidate pet character and the first pet character belonging to the same species, or second candidate pet character and the first pet character belonging to different species and a relationship between the species of the second candidate pet character and the species of the first pet character being an intimate relationship; and determine the third pet character from the second candidate pet characters.

In a possible implementation, the determining module is configured to determine a distance between each of the second candidate pet characters and the first pet character; sort each of the second candidate pet characters in a reference sequence based on the distance between each of the second candidate pet characters and the first pet character, to obtain a sorting list; and determine a second candidate pet character located before a target position in the sorting list as the third pet character.

In a possible implementation, the display module 1301 is further configured to display the third pet character in a first direction of the first pet character, a distance between the third pet character and the first pet character in the first direction being a first distance.

In a possible implementation, the display module 1301 is further configured to display, based on that the first pet character attacking an ally pet character corresponding to the virtual player character, an animation in which the third pet character executes a first interaction action; and display, based on that the virtual player character attacks the second pet character by using the ally pet character, an animation in which the third pet character executes a second interaction action, the second interaction action being different from the first interaction action.

In a possible implementation, the apparatus further includes: a trigger module, configured to trigger the combat trigger event in response to that the ally pet character corresponding to the virtual player character is summoned.

In a possible implementation, the display module 1301 is further configured to display the ally pet character at a first position in response to that the ally pet character corresponding to the virtual player character is summoned, the first position being located in a second direction of the virtual player character, and a distance between the first position and the virtual player character being a second distance.

In a possible implementation, the display module 1301 is further configured to display a summoning control, the summoning control being configured for triggering a summoning function.

The apparatus further includes: a summoning module, configured to summon the ally pet character based on that the summoning function is triggered.

In a possible implementation, the apparatus further includes: a summoning module, configured to summon the ally pet character based on an operation of controlling the virtual player character to move toward the target pet character and that a distance between the virtual player character and the target pet character is less than a distance threshold, the target pet character being the first pet character or the second pet character.

In a possible implementation, the display module 1301 is further configured to display, in response to that the ally pet character corresponding to the virtual player character is summoned, attribute information corresponding to the ally pet character, the attribute information corresponding to the ally pet character being configured for indicating a remaining attribute value of the ally pet character and an attribute threshold of the ally pet character.

In a possible implementation, the display module 1301 is further configured to display, in response to that the first pet character and the second pet character enter the turn-based combat state, attribute information corresponding to the first pet character and attribute information corresponding to the second pet character, the attribute information corresponding to the first pet character being configured for indicating a remaining attribute value of the first pet character and an attribute threshold of the first pet character, and the attribute information corresponding to the second pet character being configured for indicating a remaining attribute value of the second pet character and an attribute threshold of the second pet character.

In a possible implementation, the remaining attribute value that is of the first pet character and that is indicated by the attribute information corresponding to the first pet character is a remaining attribute value before the first pet character enters the turn-based combat state; and the remaining attribute value that is of the second pet character and that is indicated by the attribute information corresponding to the second pet character is a remaining attribute value before the second pet character enters the turn-based combat state.

In a possible implementation, the display module 1301 is further configured to display an injury identifier when the target pet character enters the turn-based combat state, based on that a remaining attribute value of the target pet character before the target pet character enters the turn-based combat state is less than an attribute threshold of the target pet character, the injury identifier being configured for indicating that the target pet character is injured, and the target pet character being the first pet character or the second pet character.

Based on the foregoing apparatus, when the virtual player character enters the turn-based combat state, the first pet character and the second pet character also enter the turn-based combat state, and the first pet character and the second pet character enter the turn-based combat state in the combat mode corresponding to the species interaction behavior performed by the first pet character and the second pet character before the first pet character and the second pet character enter the turn-based combat state, so that a relationship that is between the first pet character and the second pet character and that exists before the turn-based combat state is entered continues into the turn-based combat state. The relationship that is between the first pet character and the second pet character and that exists before the turn-based combat state is entered is consistent with a relationship that is between the first pet character and the second pet character and that exists after the turn-based combat state is entered, thereby reducing a disconnection between the relationship existing before the turn-based combat state is entered and the relationship existing after the turn-based combat state is entered, making interaction experience more complete, and improving immersion of a player, so that an interaction rate and a user retention rate can be increased.

In addition, after the virtual player character, the first pet character, and the second pet character enter the turn-based combat state, the virtual player character not only may perform a turn-based combat with the first pet character, but also may perform a turn-based combat with the second pet character, thereby reducing a limitation of an interaction by the virtual player character in a virtual world, making the interaction by the virtual player character in the virtual world more flexible and interaction manners in the virtual world more diversified, and making the interaction funnier, so that an interaction rate and a user retention rate can be increased.

In addition, a client can continuously produce various species interaction behaviors and combat modes, so that interaction diversity can be improved, and an interaction rate and a user retention rate are further increased.

When the apparatus provided above implements functions of the apparatus, only division into the foregoing function modules is used as an example for description. In the practical application, the functions may be allocated to and completed by different function modules based on requirements. In other words, an internal structure of a device is divided into different function modules, to complete all or a part of the functions described above. In addition, the apparatus provided in the foregoing examples and the method examples belong to the same concept. For the specific implementation process, refer to the method examples. Details are not described herein again.

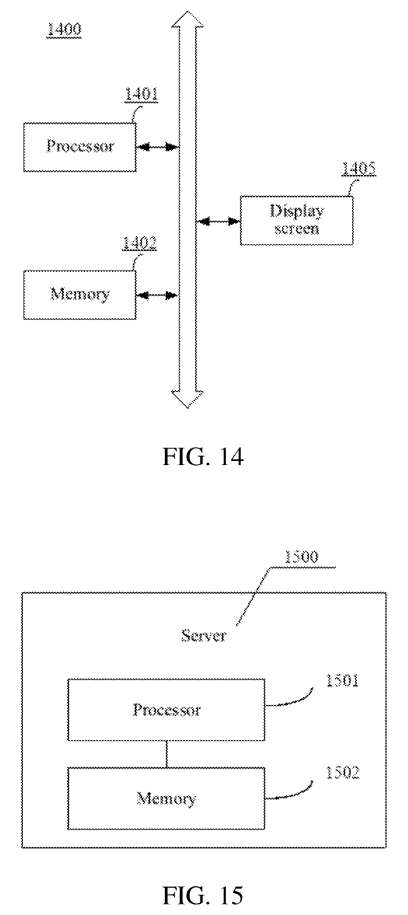

FIG. 14 shows a block diagram of a structure of a terminal device 1400 according to an example of this application. The terminal device 1400 may be any electronic device product that can perform a human-machine interaction with a user in one or more manners of a keyboard, a touch pad, a remote control, a voice interaction, a handwriting device, or the like, for example, a personal computer (PC), a mobile phone, a smartphone, a personal digital assistant (PDA), a wearable device, a pocket PC (PPC), a tablet computer, a smart on board unit, a smart television, a smart speaker, a smart watch.

Typically, the terminal device 1400 includes a processor 1401 and a memory 1402.

The processor 1401 may include one or more processing cores, and may be, for example, a 4-core processor or an 8-core processor. The processor 1401 may be implemented by using at least one hardware form of digital signal processing (DSP), a field programmable gate array (FPGA), or a programmable logic array (PLC). The processor 1401 may alternatively include a main processor and a coprocessor. The main processor is configured to process data in an active state, and is alternatively referred to as a central processing unit (CPU). The coprocessor is a low-power processor configured to process data in a standby state. In some examples, the controller 1401 may be integrated with a graphics processing unit (GPU). The GPU is configured to render and draw content that needs to be displayed on a display screen. In some examples, the processor 1401 may further include an artificial intelligence (AI) processor. The AI processor is configured to process computing operations related to machine learning.

The memory 1402 may include one or more computer-readable storage media. The computer-readable storage medium may be non-transient. The memory 1402 may further include a high-speed random memory and a nonvolatile memory, for example, one or more disk storage devices and flash memory storage devices. In some examples, the non-transient computer-readable storage medium in the memory 1402 is configured to store at least one instruction, the at least one instruction being configured to be executed by the processor 1401 to implement the virtual world-based interaction method provided in the examples of this application. In some examples, a non-transient computer-readable storage medium may alternatively be referred to as a non-volatile computer-readable storage medium.

In some examples, the terminal device 1400 may alternatively include: a display screen 1405.

The display screen 1405 is configured to display a user interface (UI). The UI may include graphics, text, icons, videos, and any combination thereof. When the display screen 1405 is a touch display, the display screen 1405 further has a capability of collecting a touch signal on or above a surface of the display screen 1405. The touch signal may be inputted to the processor 1401 as a control signal for processing. In this case, the display screen 1405 may further be configured to provide a virtual button and/or a virtual keyboard, which are/is also referred to as a soft button and/or a soft keyboard. In some examples, there may be one display screen 1405 disposed on a front panel of the terminal device 1400. In some other examples, there are at least two display screens 1405, arranged on different surfaces of the terminal device 1400 respectively or in a folded design. In some other examples, the display screen 1405 may be a flexible display screen, arranged on a curved surface or a folded surface of the terminal device 1400. Alternatively, the display screen 1405 may be even arranged in a non-rectangular irregular pattern, namely, a special-shaped screen. The display screen 1405 may be prepared by using a material such as a liquid crystal display (LCD), an organic light-emitting diode (OLED), or the like. In some examples, the first pet character, the second pet character, the control, and the like used in the method examples of this application are displayed by using the display screen 1405.

A person skilled in the art may understand that the structure shown in FIG. 14 constitutes no limitation on the terminal device 1400, and the terminal device 1400 may include more or fewer components than those shown in the figure, some components may be combined, or a different component deployment may be used.

FIG. 15 is a schematic diagram of a structure of a server according to an example of this application. The server 1500 may vary a lot due to different configurations or performance, and may include one or more central processing units (CPU) 1501 and one or more memories 1502. The one or more memories 1502 store at least one piece of program code, and the at least one piece of program code is loaded and executed by the one or more CPUs 1501 to implement the game interaction method provided in the foregoing method examples. Certainly, the server 1500 may further have components such as a wired or wireless network interface, a keyboard, and an input/output interface, to help perform input and output. The server 1500 may further include another component configured to implement a device function. Details are not described herein.

In an example, a non-volatile computer-readable storage medium is further provided, the non-volatile computer-readable storage medium has at least one piece of program code stored therein, and the at least one piece of program code is loaded and executed by a processor, to cause a computer to implement the virtual world-based interaction method according to any one of the foregoing implementations.

In one example, the non-volatile computer-readable storage medium may be a read-only memory (ROM), a random access memory (RAM), a compact disc read-only memory (CD-ROM), a magnetic tape, a floppy disk, an optical data storage device, or the like.

In an example, a computer program or a computer program product is further provided, the computer program or the computer program product has at least one computer instruction stored therein, and the at least one computer instruction is loaded and executed by a processor, to cause a computer to implement the virtual world-based interaction method according to any one of the foregoing implementations.

Information (including but not limited to user device information, user personal information, or the like), data (including but not limited to data configured for analysis, stored data, presented data, or the like), and signals involved in this application are all authorized by a user or fully authorized by various parties, and collection, use, and processing of related data need to comply with relevant laws, regulations, and standards of relevant regions.

That "plurality of" mentioned in this specification means two or more. A term "and/or" describes an association relationship between associated objects and indicates that three relationships may exist. For example, A and/or B may indicate the following cases: Only A exists, both A and B exist, and only B exists. The character "/" generally indicates an "or" relationship between the associated objects.

The foregoing descriptions are merely examples of this application, and are not intended to limit this application. Any modification, equivalent replacement, or improvement made within the principle of this application shall fall within the protection scope of this application.

What is claimed is:

1. A virtual world-based interaction method, performed by a computer device, the method comprising:
displaying a first pet character and a second pet character in a virtual world;
displaying that the first pet character and the second pet character perform a species interaction behavior;
controlling, in response to a combat trigger event, a virtual player character to switch from a virtual world exploration state to a turn-based combat state; and
controlling the first pet character and the second pet character to enter the turn-based combat state in a combat mode corresponding to the species interaction behavior.

2. The method according to claim 1, wherein the species interaction behavior comprises an intra-specific interaction behavior, and the displaying that the first pet character and the second pet character perform the species interaction behavior comprises:
displaying, based on the first pet character and the second pet character belonging to the same species, that the first pet character and the second pet character perform the intra-specific interaction behavior.

3. The method according to claim 2, wherein the controlling, in response to the combat trigger event, the virtual player character to switch from the virtual world exploration state to the turn-based combat state comprises:
in response to the combat trigger event when the species interaction behavior between the first pet character and the second pet character is an intra-specific interaction behavior or an inter-specific intimate interaction behavior, controlling the virtual player character to switch from the virtual world exploration state to the turn-based combat state, and controlling the first pet character and the second pet character to enter the turn-based combat state in a first combat mode, the first combat mode indicating that the first pet character and the second pet character attack the virtual player character when the virtual player character attacks the first pet character or the second pet character.

4. The method according to claim 1, wherein the species interaction behavior comprises an inter-specific interaction behavior, and the displaying that the first pet character and the second pet character perform the species interaction behavior comprises:
displaying, based on the first pet character and the second pet character belonging to different species, that the first pet character and the second pet character perform the inter-specific interaction behavior.

5. The method according to claim 4, wherein the inter-specific interaction behavior comprises an inter-specific intimate interaction behavior and an inter-specific hostile interaction behavior; and
the displaying, based on the first pet character and the second pet character belonging to different species, that the first pet character and the second pet character perform the inter-specific interaction behavior comprises:
displaying, based on the first pet character and the second pet character belonging to different species and a relationship between the species of the first pet character and the species of the second pet character being an intimate relationship, that the first pet character and the second pet character perform the inter-specific intimate interaction behavior; and
displaying, based on the first pet character and the second pet character belonging to different species and a relationship between the species of the first pet character and the species of the second pet character being a hostile relationship, that the first pet character and the second pet character perform the inter-specific hostile interaction behavior.

6. The method according to claim 5, wherein the controlling, in response to the combat trigger event, the virtual player character to switch from the virtual world exploration state to the turn-based combat state comprises:
in response to the combat trigger event when the first pet character and the second pet character belong to different species and a relationship between the species of the first pet character and the species of the second pet character is a hostile relationship, controlling the virtual player character to switch from the virtual world exploration state to the turn-based combat state, and controlling the first pet character and the second pet character to enter the turn-based combat state in a second combat mode, the second combat mode indicating that a target pet character attacks the virtual player character when the virtual player character attacks the target pet character, and the target pet character being the first pet character or the second pet character.

7. The method according to claim 1, further comprising:
determining a third pet character in response to the first pet character entering the turn-based combat state, the third pet character and the first pet character belonging to the same species, or the third pet character and the first pet character belonging to different species and a relationship between the species of the third pet character and the species of the first pet character being an intimate relationship; and
controlling the third pet character to enter the turn-based combat state, the third pet character being configured for helping the first pet character.

8. The method according to claim 7, wherein the determining the third pet character in response to the first pet character entering the turn-based combat state comprises:
determining a candidate area based on current position information of the first pet character in response to the first pet character entering the turn-based combat state;
determining that first candidate pet characters are located in the candidate area; and
determining the third pet character from the first candidate pet characters.

9. The method according to claim 8, wherein the determining the third pet character from the first candidate pet characters comprises:
determining second candidate pet characters from the first candidate pet characters, the second candidate pet character and the first pet character belonging to the same species, or the second candidate pet character and the first pet character belonging to different species and a relationship between the species of the second candidate pet character and the species of the first pet character being an intimate relationship; and
determining the third pet character from the second candidate pet characters.

10. The method according to claim 9, wherein the determining the third pet character from the second candidate pet characters comprises:
determining a distance between each of the second candidate pet characters and the first pet character;
sorting each of the second candidate pet characters in a reference sequence based on the distance between each of the second candidate pet characters and the first pet character, to obtain a sorting list; and
determining a second candidate pet character located before a reference position in the sorting list as the third pet character.

11. The method according to claim 7, further comprising:
displaying the third pet character in a first direction of the first pet character, a distance between the third pet character and the first pet character in the first direction being a first distance.

12. The method according to claim 7, further comprising:
displaying, based on the first pet character attacking an ally pet character corresponding to the virtual player character, an animation in which the third pet character executes a first interaction action; and
displaying, based on the virtual player character attacking the first pet character using the ally pet character, an animation in which the third pet character executes a second interaction action, the second interaction action being different from the first interaction action.

13. The method according to claim 1, further comprising:
triggering the combat trigger event in response to an ally pet character corresponding to the virtual player character being summoned.

14. The method according to claim 13, further comprising:
displaying the ally pet character at a first position in response to the ally pet character corresponding to the virtual player character being summoned, the first position being located in a second direction of the virtual player character, and a distance between the first position and the virtual player character being a second distance.

15. The method according to claim 13, further comprising:
displaying a summoning control configured to trigger a summoning function; and
summoning the ally pet character based on the summoning function being triggered.

16. The method according to claim 13, further comprising:
summoning the ally pet character based on an operation of controlling the virtual player character to move toward a target pet character and a distance between the virtual player character and the target pet character being less than a distance threshold, the target pet character being the first pet character or the second pet character.

17. The method according to claim 13, further comprising:
displaying, in response to the ally pet character corresponding to the virtual player character being summoned, attribute information corresponding to the ally pet character, the attribute information corresponding to the ally pet character being configured for indicating a remaining attribute value of the ally pet character and an attribute threshold of the ally pet character.

18. The method according to claim 1, further comprising:
displaying, in response to the first pet character and the second pet character entering the turn-based combat state, attribute information corresponding to the first pet character and attribute information corresponding to the second pet character, the attribute information corresponding to the first pet character indicating a remaining attribute value of the first pet character and an attribute threshold of the first pet character, and the attribute information corresponding to the second pet character indicating a remaining attribute value of the second pet character and an attribute threshold of the second pet character.

19. An apparatus for virtual world-based interaction, comprising:
one or more processors; and
memory storing instructions that, when executed by the one or more processors; cause the apparatus to:
display a first pet character and a second pet character in a virtual world;
display that the first pet character and the second pet character perform a species interaction behavior;
control, in response to a combat trigger event, a virtual player character to switch from a virtual world exploration state to a turn-based combat state; and
control the first pet character and the second pet character to enter the turn-based combat state in a combat mode corresponding to the species interaction behavior.

20. A non-transitory computer-readable medium storing instructions that, when executed, cause:
displaying a first pet character and a second pet character in a virtual world;
displaying that the first pet character and the second pet character perform a species interaction behavior;
controlling, in response to a combat trigger event, a virtual player character to switch from a virtual world exploration state to a turn-based combat state; and
controlling the first pet character and the second pet character to enter the turn-based combat state in a combat mode corresponding to the species interaction behavior.
